(19) United States
(12) Patent Application Publication
(10) Pub. No.: US 2023/0029697 A1
(43) Pub. Date: Feb. 2, 2023

(54) DYNAMIC ACTION IDENTIFICATION FOR COMMUNICATION PLATFORM

(71) Applicant: salesforce.com, inc., San Francisco, CA (US)

(72) Inventors: Nicolas Kruk, Raleigh, NC (US); Joseph Leong, Raleigh, NC (US); Robert Duffy, Bellevue, WA (US)

(21) Appl. No.: 17/388,791

(22) Filed: Jul. 29, 2021

(51) Int. Cl. G06N 5/04; G06N 20/00

(52) U.S. Cl. CPC G06N 5/04; G06N 20/00

(57) ABSTRACT

A method that includes monitoring, by a communication service that is a participant to a channel of a communication platform, multiple inputs to the channel by other participants to the channel, where the communication service is configured to execute one or more machine learning models and access one or more external data platforms that are linked to the channel. The method may further include identifying, by the communication service and based on processing of an input by the one or more machine learning models, an action associated with a first external data platform, where the action is identified from a set of actions that are associated with the first external data platform and preconfigured for the communication platform. The method may further include triggering, by the communication service and based on identifying the action, execution of the action using data from the first external data platform.

### FIELD OF TECHNOLOGY

The present disclosure relates generally to database systems and data processing, and more specifically to dynamic action identification for communication platform.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cases, the cloud platform may support a communication platform that is configured with a set of actions. Users of the communication platform may perform these actions by manually interacting with the communication platform. Some actions may involve a relatively large number of steps or may take a relatively long time to perform. As a result, performing actions at the communication platform may be a relatively inefficient process.

### BRIEF DESCRIPTION OF THE DRAWINGS

FIG. 1 illustrates an example of a data processing system that supports dynamic action identification for communication platform in accordance with aspects of the present disclosure.

FIG. 2 illustrates an example of a data processing system that supports dynamic action identification for communication platform in accordance with aspects of the present disclosure.

FIG. 3 illustrates an example of a data processing system that supports dynamic action identification for communication platform in accordance with aspects of the present disclosure.

FIG. 4 illustrates an example of a process flow that supports dynamic action identification for communication platform in accordance with aspects of the present disclosure.

FIG. 5 shows a block diagram of an apparatus that supports dynamic action identification for communication platform in accordance with aspects of the present disclosure.

FIG. 6 shows a block diagram of a communication manager that supports dynamic action identification for communication platform in accordance with aspects of the present disclosure.

FIG. 7 shows a diagram of a system including a device that supports dynamic action identification for communication platform in accordance with aspects of the present disclosure.

FIGS. 8 through 11 show flowcharts illustrating methods that support dynamic action identification for communication platform in accordance with aspects of the present disclosure.

### DETAILED DESCRIPTION

In some data processing systems, a cloud platform (e.g., a computing platform for cloud computing) may support a communication platform. The communication platform may enable users (e.g., participants) of the communication platform to exchange messages with other users of the communication platform. A user of the communication platform may access the communication platform based on downloading software associated with the communication platform and activating a user interface component configured for the communication platform. In some examples, the communication platform may be an example of a web application that is accessible via another application, such as a web browser. The communication platform may include a chat window, a dashboard, one or more sidebar components, one or more interactive features (e.g., buttons, links, tools), and various settings that can be configured by users at the user interface component.

The communication platform may support various channels (e.g., chat windows, chat instances, chat sessions) in which users of the communication platform can exchange messages. Each channel may be associated with a set of user identifiers and a set of configurable attributes (e.g., display attributes, formatting attributes). A first user of the communication platform may create a channel based on interacting with the user interface component configured for the communication platform. After creating the channel, the first user may invite other users to the channel based on selecting (e.g., at the user interface component) user identifiers associated with the other users. The communication platform may transmit an invitation to the other users based on the selection of the first user. Once the other users have accepted the invitation, the other users may exchange messages with the first user in the channel (e.g., in a chat window associated with the channel). In some cases, the communication platform and/or a channel within the communication platform may support various actions that a user may perform via the communication platform. In some examples, the actions may be performed on or using an external service.

As such, the communication platform may be configured to activate an external service, such as a video chat service. Accordingly, a channel of the communication platform may be configured with actions that enable users to interact with the external service. For example, the communication platform may enable users to start a video chat on the external service by entering some information into the channel. However, users may only be able to perform this action by manually interacting with a user interface associated with the communication platform. As a result, performing these actions may be a relatively inefficient process and these actions may need to be directly supported by the communication platform.

In accordance with aspects of the present disclosure, the communication platform may be configured with a communication service that autonomously triggers actions (e.g., at the communication platform or an external data platform) based on monitoring a channel of the communication platform. Specifically, the communication service may monitor the channel, analyze one or more inputs to the channel (e.g., messages sent from other users), identify an action to perform based on analyzing the one or more inputs, and autonomously trigger execution of the identified action. The communication service may be supported by one or more cloud platforms, application servers, or computing devices.

In some examples, the communication service may include a monitoring component that monitors the channel, an analyzing component that analyzes a received input to the channel, a querying component that submits queries to external data platforms, a generating component that autonomously generates content (e.g., at the communication platform or an external data platform), and a feedback component that receives feedback from users in the channel. The analyzing component of the communication service may be connected to one or more machine learning models that are configured to perform a natural language processing (NLP) analysis on inputs to the channel. The communication service may be an example of a chat bot, virtual assistant, or the like that is supported via various software and hardware components. In some examples, the communication service may be a participant to the channel, and as such, may access the inputs into the channel by the user to perform the techniques described herein. Configuring the communication service to autonomously monitor the channel and trigger actions may enable users of the communication platform to perform actions with reduced manual interaction and improved efficiency, among other benefits. Additionally, as described herein, the communication service may be configured to access multiple types of external data platforms in order to support action triggering. As such, the techniques described herein may enhance user experience and improve processing and communication efficiency.

Aspects of the disclosure are initially described in the context of an environment supporting an on-demand database service. Aspects of the disclosure are illustrated by and described with reference to data processing systems and process flows. Aspects of the disclosure are further illustrated by and described with reference to apparatus diagrams, system diagrams, and flowcharts that relate to dynamic action identification for communication platform.

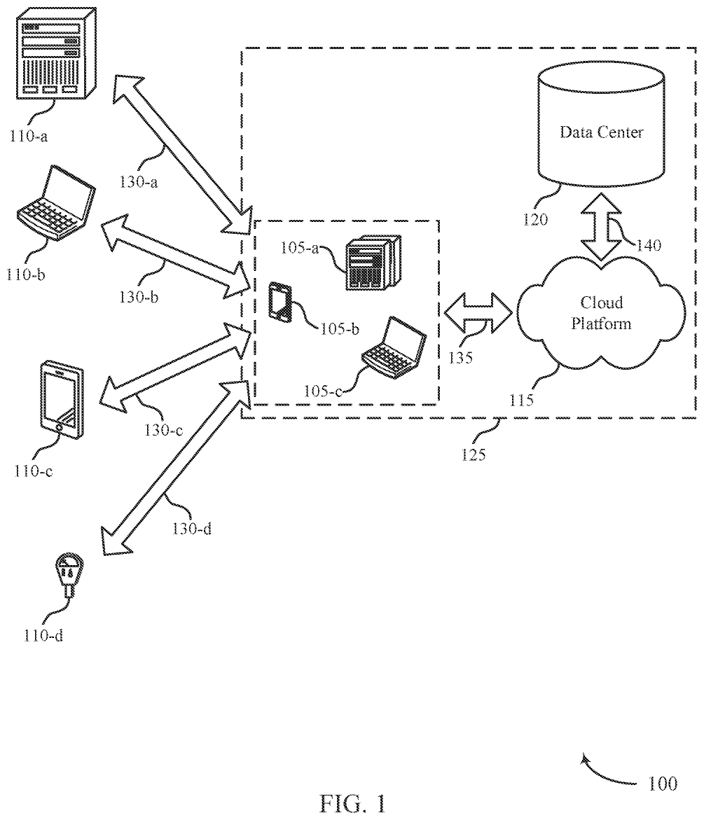

FIG. 1 illustrates an example of a data processing system 100 for cloud computing that supports dynamic action identification for communication platform in accordance with various aspects of the present disclosure. The data processing system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

In some data processing systems 100, a cloud platform 115 may support a communication platform (e.g., a software application). The communication platform may enable users (e.g., contacts 110) to exchange messages via a user interface component associated with the communication platform. The communication platform may support various channels in which users can exchange messages. Additionally or alternatively, the communication platform may be connected to various external data platforms. Some channels of the communication platform may be configured with actions that enable users to interact with the various external data platforms. In some cases, however, users may only be able to perform these actions by manually interacting with the user interface component. Manually performing actions at the communication platform may be relatively complex and inefficient. In addition, some actions associated with the external data platforms may not be supported by the communication platform, which may limit the usability of the communication platform.

In accordance with the described techniques, the communication platform may be configured with a communication service that autonomously triggers actions (e.g., at the communication platform or an external data platform) based on monitoring a channel of the communication platform. In some examples, the communications service may be configured as another user (e.g., a participant) of the channel. The communication service may monitor one or more inputs to the channel (e.g., messages sent from other users) and may identify an action to perform based on analyzing the one or more inputs. Specifically, the communication service may use one or more machine learning models to perform an NLP analysis on the inputs and may identify the action based on performing the NLP analysis. Configuring the communication service to autonomously monitor channels and trigger actions may enable users of the communication platform to perform actions with reduced manual interaction and improved efficiency, among other benefits. In addition, the communication service may support the techniques described herein with limited or no configuration of the communication platform itself. That is, the communication service may support actions that are not directly supported by or preconfigured for the communication platform.

As an example, a group of users may exchange messages within a channel of the communication platform. The group of users may be discussing a segment of code that is stored at an external data platform. The communication service may monitor the channel and extract contextual information from the messages based on using one or more machine learning models to perform an NLP analysis on the messages. The communication service may determine that the group of users is discussing a segment of code from the external data platform based on the NLP analysis and may submit a query to the external data platform based on this determination. In some examples, the communication service may identify the segment of code, a uniform resource locator (URL) corresponding to the segment of code, or user identifiers associated with the segment of code (e.g., lead developers or contributors to the segment of code) based on querying the external data platform. The communication service may display this information to the group of users within the channel. For example, the communication service may post a link (e.g., the URL) to the segment of code in the channel such that the group of users can interact with the segment of code. Additionally or alternatively, the communication service may generate a suggestion to add one of the related user identifiers (e.g., contributors) to the channel.

In another example, the group of users may be discussing an error that one of the users experienced while testing a software application. The communication service may identify the error (or the error discussion) based on monitoring the channel and using the one or more machine learning models to perform an NLP analysis on messages sent in the channel. In response to identifying the error, the communication service may post an issue related to the identified error on an external data platform. In some examples, the communication service may request an input from the group of users prior to posting the issue on the external data platform. The communication service may also be configured to post the issue on the external data platform using a profile (e.g., an account) associated with one of the users. For example, if a first user in the group has an account linked to the external data platform, the communication service may be configured to post the issue under the account of the first user. Additionally or alternatively, the communication service may identify an article (e.g., a forum discussion on how to fix the identified error) or a segment of code related to the error and may post this information in the channel.

It should be appreciated by a person skilled in the art that one or more aspects of the disclosure may be implemented in a data processing system 100 to additionally or alternatively solve other problems than those described herein. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

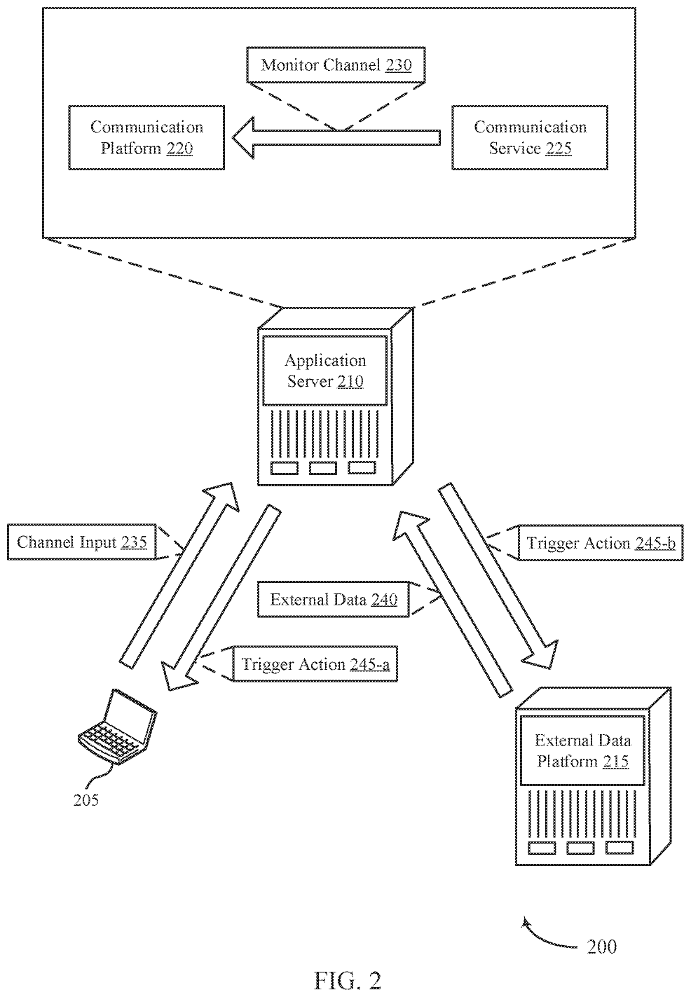

FIG. 2 illustrates an example of a data processing system 200 that supports dynamic action identification for communication platform in accordance with aspects of the present disclosure. The data processing system 200 may implement or be implemented by aspects of the data processing system 100. For example, the data processing system 200 may include a user device 205, an application server 210, and an external data platform 215. The application server 210 may support a communication service 225 and a communication platform 220. In the data processing system 200, the communication service 225 may automatically trigger actions 245 based on monitoring a channel 230 of the communication platform 220.

The application server 210 (which may be associated with a cloud platform 115 as described with reference to FIG. 1) may support a communication platform 220. The communication platform 220 may enable participants (e.g., users) to exchange messages, documents, links, and other content within various channels of the communication platform 220. A participant may refer to a user (e.g., a contact 110 or a cloud client 105 as described with reference to FIG. 1) of the communication platform, a user identifier corresponding to a user of the communication platform, a user profile associated with a user of the communication platform, a user device used to interact with the communication platform, a profile that is managed by the communication service 225, or a combination thereof. Some channels (e.g., chat rooms) of the communication platform 220 may correspond to specific tasks or projects. In these channels, participants may exchange messages and other content related to the specific tasks. Thus, participants that are working on a specific project may be members of a channel 230 in which the project is discussed.

The communication platform 220 may be connected to an external data platform 215. Although illustrated as being connected to a single external data platform 215, it is to be understood that the application server 210 may be connected to any number of external data platforms 215. The external data platform 215 may be associated with a preconfigured set of actions, which may include generating a document, scheduling a meeting, setting up a poll, creating a work item, updating a database, retrieving code, or performing a query, among other examples. The preconfigured set of actions may depend on the type or purpose of the external data platform 215. Additionally, the communication platform 220 may be associated with a second set of preconfigured actions, which may include adding participants to a channel 230, removing participants from a channel 230, updating a configuration of a channel 230, tagging participants in messages, or reacting to messages in the channel 230, among other examples.

Users of the communication platform 220 may perform these actions directly (e.g., at the external data platform 215) or indirectly (e.g., through the communication platform 220). In some cases, indirectly performing actions through the communication platform 220 may be more efficient than directly performing the actions at the external data platform 215. For example, generating a document at the external data platform 215 by interacting with the communication platform 220 may involve less manual interaction (e.g., fewer clicks) than navigating to the external data platform 215 and generating the document directly. However, indirectly performing actions through the communication platform 220 may still be associated with a relatively high amount of manual interaction. For example, some actions may include a relatively high number of steps or may take a relatively long time to complete. As such, performing actions related to the external data platform 215 may be a relatively inefficient process.

In accordance with aspects of the present disclosure, the communication platform 220 may be configured with a communication service 225 that can automatically trigger execution of actions based on monitoring a channel 230 of the communication platform 220. In some examples, the communication service 225 may be configured as a participant to the channel 230. The communication service 225 may detect one or more inputs 235 (e.g., a message) to the channel 230, extract contextual information from the inputs 235, determine an action to perform based on the extracted contextual information, and autonomously trigger the determined action (e.g., at the communication platform 220 or the external data platform 215). The contextual information may include any relevant data associated with the inputs 235. For example, the contextual information may include text from the inputs 235, a project or a service related to the inputs 235, a time at which the inputs 235 were detected, a user that sent the inputs 235 in the channel 230, an intended recipient of the inputs 235, an objective or directive associated with the inputs 235, recent interactions in the channel 230 prior to the inputs 235, or a combination thereof. In some examples, the contextual information may be inferred (e.g., not explicitly stated in the inputs 235). For example, the contextual information, such as a topic of discussion (project, issue, etc.) may be inferred based on one or more inputs by various participants to the channel. The communication service 225 may extract the contextual information from the inputs 235 based on using one or more machine learning models to perform an NLP analysis on the inputs 235.

In some examples, the one or more machine learning models may be trained for different purposes. For example, a first machine learning model may be configured to perform an NLP analysis on text from the inputs 235 and a second machine learning model may be configured to query the external data platform 215 based on a result of the NLP analysis performed by the first machine learning model. Additionally or alternatively, a third machine learning model may be configured to receive data from the external data platform 215 (e.g., based on the querying) and modify the received data for display in the communication platform 220. For example, the third machine learning model may be configured to autonomously generate a document that includes the received data. In some examples, the one or more machine learning models may be trained using different data types. For example, some of the machine learning models may be trained with a dataset that includes text (e.g., emails, documents, text messages), while other machine learning models may be trained using data from the external data platform 215 (e.g., a code database). As such, if the communication service 225 determines that the inputs 235 are related to the external data platform 215, the communication service 225 may trigger the machine learning models configured for the external data platform 215. Thus, if the communication service 225 determines that the inputs 235 correspond to or reference code (e.g., using a NLP technique), the communication service 225 may use a machine learning model trained on a codebase (e.g., the external data platform 215) to identify a code library, module, or the like associated with the discussion in the channel 230. The communication service 225 may use the identified code to trigger an action, such as posting within the channel 230, generating a suggestion to add a user (e.g., a developer of the code) into the channel, posting an issue, or posting a pull request, among other examples.

As an example, a user device 205 (e.g., a participant) may send an input 235 (e.g., a message) in the channel 230. The communication service 225 may monitor the channel 230 and may detect the input 235. After detecting the input 235, the communication service 225 may extract contextual information from the input 235 based on using the one or more machine learning models to perform an NLP analysis on the input 235. In some examples, the one or more machine learning models may be trained prior to performing the NLP analysis. In some examples, the communication service 225 may submit a query to the external data platform 215 based on the extracted contextual information and may receive data 240 from the external data platform 215 in response to the query. The communication service 225 may identify actions associated with the external data platform 215 based on the data 240 and may select one or more of the actions based on the data 240, the input 235, the extracted contextual information, or a combination thereof.

The communication service 225 may autonomously trigger the selected actions at the communication platform 220, the external data platform 215, or both. In some examples, a triggered action 245-a may include triggering display of a user interface component, such as a sidebar component, at the user device 205. The displayed user interface component may include the data 240 from the external data platform 215. In response to triggering display of the user interface component, a participant at the user device 205 may select or otherwise interact with one or more features of the user interface component. The communication service 225 may receive an indication (e.g., via the communication platform 220) that the user device 205 has interacted with these features and may update the one or more machine learning models based on the indication.

In some examples, the triggered action 245-a may be performed at the communication platform 220. For example, the triggered action 245-a may include adding one or more participants to the channel 230 or removing one or more participants from the channel 230. In other examples, a triggered action 245-b may be performed at the external data platform 215. For example, if the triggered action 245-b includes updating code (e.g., a pull request) that is stored at the external data platform 215, the communication service 225 may directly update the code at the external data platform 215. In some examples, the communication service 225 may transmit an indication to the user device 205 after completion of the triggered action 245-b.

In one example, a participant at the user device 205 may tag one or more messages in the channel 230. The tagged messages may be related to an upcoming project, a work item, an impending deadline, an internal record, an important question, or a data structure, among other examples. The communication service 225 may aggregate and display the tagged messages in a user interface component at the communication platform 220. Displaying the tagged messages in a separate user interface component may enable the participant to quickly locate and interact with the tagged messages without scrolling (e.g., parsing) through other messages in the channel 230. Additionally or alternatively, the communication service 225 may be configured to perform actions at the external data platform 215 based on the tagged messages. For example, the communication service 225 may generate a work item (e.g., an issue) at the external data platform 215 based on contextual information in the tagged messages. In another example, the communication service 225 may generate a document (e.g., on an external data platform 215 that supports document generation and editing) that includes the tagged messages or information associated with the tagged messages (e.g., users, topics, timestamps).

In another example, the participant at the user device 205 may enter a command (e.g., a shortcut) related to a preconfigured action and the communication service 225 may perform the preconfigured action based on detecting the command. For example, the participant may enter a command that instructs the communication service 225 to determine a suitable meeting time for users in the channel 230 based on availabilities of the users. Similarly, the participant may enter a command that instructs the communication service 225 to generate a document at the external data platform 215 using contextual information from messages exchanged in the channel 230.

Configuring the communication service 225 to autonomously trigger actions 245 may enable participants of the channel 230 to perform actions with reduced manual interaction and greater efficiency, among other benefits. For example, the described techniques may enable participants of the channel 230 to generate content (e.g., documents, meetings, work items) or modify the channel 230 (e.g., add participants to the channel 230 or remove participants from the channel 230) without manually interacting with the communication platform 220 or the external data platform 215.

Thus, the communication service 225 may leverage one or more machine learning models as well as one or more external data platforms 215 to support improved user experience at the communication platform 220. As described herein, each external data platform 215 may be associated with a different preconfigured set of actions. As an example, for an external data platform 215 that includes a datastore of potential users or participants (e.g., employees of an organization), the set of preconfigured actions may include adding a user to the channel 230, sending a message (e.g., email, text, direct message on the communication platform 220) to a user, identifying contact information (e.g., such that the information is posted in the channel 230), identification of work items associated with users (e.g., identification of projects to which the users contributed). In the case of project identification for a user, the communication service 225 may also query a codebase for the user contributions to a segment of code in order to execute an action (e.g., posting the segment of code into the channel 230 or posting a link to the segment of code into the channel 230). In the case of the external data platform 215 being a document editing service, the set of preconfigured actions may include generating and/or editing a document or posting portions of documents into the channel 230, among other examples. In the case of the external data platform 215 being a code repository (e.g., GitHub), the set of preconfigured actions may include posting a pull request, posting portions of code into the channel 230, identifying contributors to the code, or posting an issue, among other examples.

Thus, as each external data platform 215 may be associated with a different set of preconfigured actions, the communication service 225 may use the inputs 235 to identify one or more appropriate external data platforms 215 (e.g., using NLP and/or various machine learning models), identify one or more preconfigured set of actions for each of the identified one or more appropriate machine learning models, and trigger the identified action on the external data platform 215 and/or in the channel 230. More particularly, each action may be performed on the external data platform 215 itself or in the channel 230. Further, each action may use data from the external data platform 215 (e.g., code data, issue data, user data).

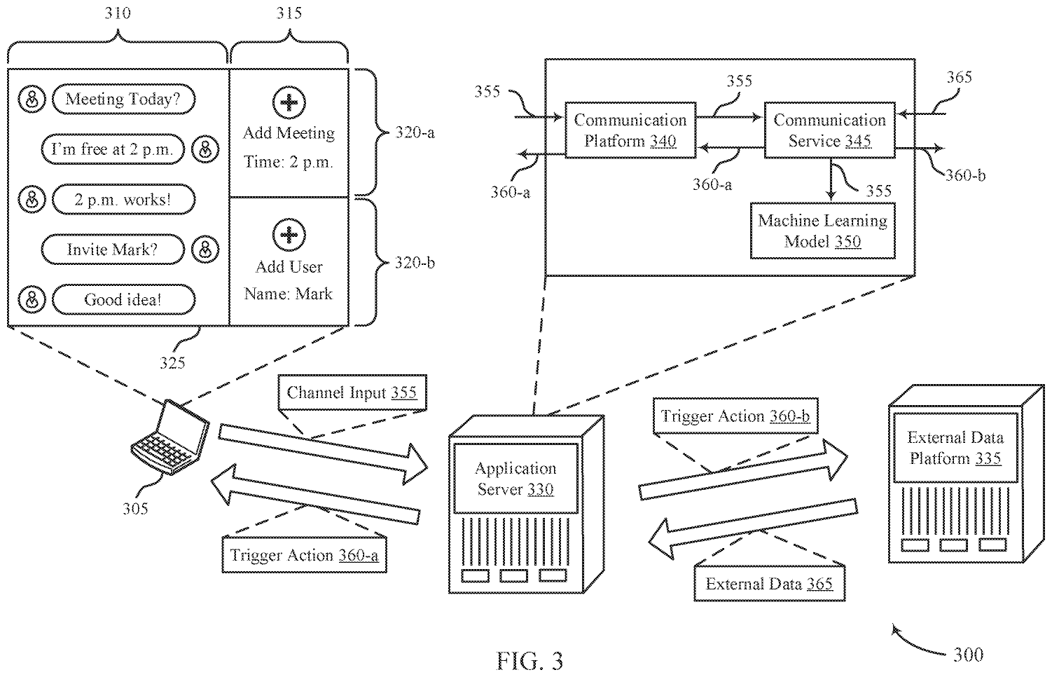

FIG. 3 illustrates an example of a data processing system 300 that supports dynamic action identification for communication platform in accordance with aspects of the present disclosure. The data processing system 300 may implement or be implemented by aspects of the data processing system 100 and the data processing system 200. For example, the data processing system 300 may include a user device 305, an application server 330, and an external data platform 335, which may be examples of corresponding devices described herein with reference to FIG. 2. The application server 330 may support a communication platform 340 and a communication service 345, which may be examples of a communication platform 220 and a communication service 225 described with reference to FIG. 2. In the data processing system 300, the communication service 345 may automatically trigger actions 360 based on monitoring a channel of the communication platform 340.

The application server 330 may support a communication platform 340, which may enable the user device 305 (e.g., a participant) to communicate with other user devices (not shown) via a channel of the communication platform 340. In some examples, the communication platform 340 may include a user interface component 325 associated with the channel. The user interface component 325 may include a chat window component 310 and a sidebar component 315. The user device 305 may exchange messages with other user devices in the chat window component 310. The communication platform 340 may also be connected with an external data platform 335. Although illustrated as being connected to a single external data platform 335, it is to be understood that the communication platform may be connected to any number of external data platforms 335.

In accordance with the described techniques, the communication platform 340 may be configured with a communication service 345 that can automatically trigger execution of actions 360 based on monitoring a channel of the communication platform 340. Specifically, the communication service 345 may monitor an input 355 (e.g., a message) to the channel, extract contextual information from the input 355, identify an action to perform based on the extracted contextual information, and autonomously perform the identified action. In some examples, the communication service 345 may be connected to the external data platform 335 such that the communication service 345 can perform actions specific to the external data platform 335.

As an example, the user device 305 may send an input 355 (e.g., “Invite Mark?”) to the channel of the communication platform 340. The communication service 345 may use the one or more machine learning models 350 to perform an NLP analysis on the input 355. The communication service 345 may extract contextual information from the input 355 based on performing the NLP analysis. The communication service 345 may submit a query to the external data platform 335 based on the extracted contextual information and may receive data 365 from the external data platform 335 in response to the query.

In some examples, the query may include the extracted contextual information, one or more attributes of the input 355 (e.g., a timestamp), one or more attributes of the channel (e.g., the channel name), one or more user identifiers associated with the input 355 (e.g., a sending user identifier, a receiving user identifier), or a combination thereof. In some examples, the data 365 may include user identifiers, external content (e.g., code), a URL, or other information pertaining to the query.

The communication service 345 may identify a set of actions 360 associated with the external data platform 335 based on receiving the data 365 from the external data platform 335. The set of actions 360 may be preconfigured for the communication platform 340. The communication service 345 may select an action 360 from the set of actions 360 based on the data 365, the extracted contextual information, the input 355, results of the query, or a combination thereof. Accordingly, the communication service 345 may trigger execution of the selected action 360 using the data 365 from the external data platform 335.

In some examples, the communication service 345 may trigger execution of an action 360-a at the user device 305. For example, the communication service 345 may trigger display of an interactive component 320-a or an interactive component 320-b in the sidebar component 315 of the user interface component 325 at the user device 305. More specifically, the communication service 345 may trigger a suggestion to add a participant (e.g., “Mark”) to the channel based on a first message (e.g., “Invite Mark?”). Additionally or alternatively, the communication service 345 may trigger a suggestion to schedule a meeting (e.g., at 2 p.m.) based on a second message (e.g., “2 p.m. works!”).

After triggering display of the interactive components 320, the participant at the user device 305 may click on one or more of the interactive components 320. For example, the participant may click on the interactive component 320-b to add another participant to the channel. In response to clicking on the interactive component 320-b, the communication platform 340 may add the corresponding user identifier to the channel. Alternatively, if the participant does not click any of the interactive components 320, the communication service 345 may use this information to update the one or more machine learning models 350. In some examples, the communication service 345 may request feedback from the participant at the user device 305. If the participant provides the requested feedback, the communication service 345 may use this feedback to update the one or more machine learning models 350 such that the communication service 345 can trigger actions 360 that are more applicable to the participant.

In some examples, the communication service 345 may trigger execution of an action 360-b at the external data platform 335. For example, the communication service 345 may generate a document at the external data platform 335 or may update code stored at the external data platform 335. Configuring the communication service 345 to automatically perform actions 360 may enable users of the communication platform 340 to perform actions 360 with reduced manual interaction and improved efficiency, among other benefits.

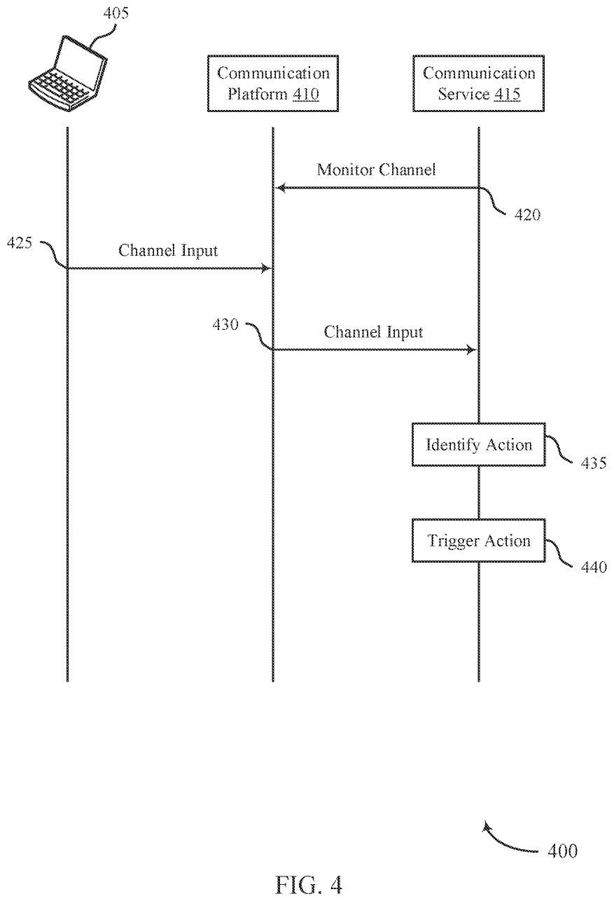

FIG. 4 illustrates an example of a process flow 400 that supports dynamic action identification for communication platform in accordance with aspects of the present disclosure. The process flow 400 may implement or be implemented by aspects of the data processing system 100, the data processing system 200, and the data processing system 300. For example, the process flow 400 may include a user device 405, a communication platform 410, and a communication service 415, which may be examples of corresponding devices described herein with reference to FIGS. 1-3. In the following description of the process flow 400, operations between the user device 405, the communication platform 410, and the communication service 415 may be performed in a different order or at a different time than as shown. Additionally or alternatively, some operations may be omitted from the process flow 400, and other operations may be added to the process flow 400. In accordance with the process flow 400, the communication service 415 may trigger an action based on monitoring a channel of the communication platform 410.

At 420, the communication service 415 may monitor a channel (e.g., a chat window) of the communication platform 410. Specifically, the communication service 415 may monitor multiple inputs to the channel, which may include messages, temporal data (e.g., timestamps) associated with the messages, data attributes associated with participants to the channel, configuration data associated with the channel, or a combination thereof. The communication service 415 may be configured to execute one or more machine learning models and access one or more external data platforms (e.g., databases, websites) that are linked to the channel. In some examples, each of the one or more external data platforms may be associated with a different set of preconfigured actions for the communication platform.

At 425, the user device 405 may send an input to the channel. For example, the user device 405 may send a message in the channel based on interacting with a user interface component at the communication platform 410. At 430, the communication service 415 may analyze the input of the user device 405. For example, the communication service 415 may use the one or more machine learning models to perform an NLP analysis on the input.

The communication service 415 may extract contextual information (e.g., user identifiers, timestamps, actions) from the input based on performing the NLP analysis. In some examples, the communication service 415 may query the one or more external data platforms based on the extracted contextual information. The communication service 415 may receive data from a first external data platform in response to querying the one or more external data platforms and may determine a set of actions associated with the first external data platform based on receiving the data from the first external data platform.

At 435, the communication service 415 may identify an action (e.g., from the set of actions associated with the first external data platform) based on the input, the extracted contextual information, a result of the NLP analysis, the data from the first external data platform, or a combination thereof. The identified action may be preconfigured for the communication platform. In some examples, the identified action may include generating content, adding users to the channel, removing users from the channel, tagging participants in the channel, posting a link to the first external data platform, displaying results of the query, or a combination thereof.

At 440, the communication service 415 may trigger execution of the action using data from the first external data platform. In some examples, the communication service 415 may trigger execution of the action at the first external data platform. In other examples, the communication service 415 may trigger execution of the action at the user device 405. For example, the communication service 415 may trigger a user interface component at the user device 405 and may trigger display of the action, the data from the first external data platform, or both in the user interface component. In some examples, the user interface component may include a sidebar, a chat input, or both. That is, the communication service 415 may display the action, the data, or both as an interactive sidebar component or as an input to the channel.

In some examples, the communication service 415 may generate content based on triggering execution of the action. For example, the communication service 415 may generate a document, a user profile, a work item, or a URL associated with the first external data platform. In such examples, the user device 405 may interact with the generated content at the communication platform 410. For example, if the communication service 415 generates a document and triggers display of the generated document at the communication platform 410, the user device 405 may interact with the generated document at the communication platform 410. In some examples, the communication service 415 may receive an indication that the user device 405 has interacted with the generated content at the communication platform 410. For example, the communication service 415 may receive an indication that the user device 405 has selected a subset of the data from the first external data platform. In some examples, the communication service 415 may update the one or more machine learning models based on the user device 405 interacting with the generated content at the communication platform 410.

Configuring the communication service 415 to autonomously trigger actions at the communication platform 410 or the first external data platform may enable the user device 405 (e.g., a participant to the channel) to perform actions associated with the communication platform 410 or the first external data platform with reduced manual interaction and improved efficiency. For example, automatically triggering actions may enable the user device 405 to generate content, schedule meetings, add participants, or perform related activities with fewer clicks (e.g., in comparison to manually performing these actions).

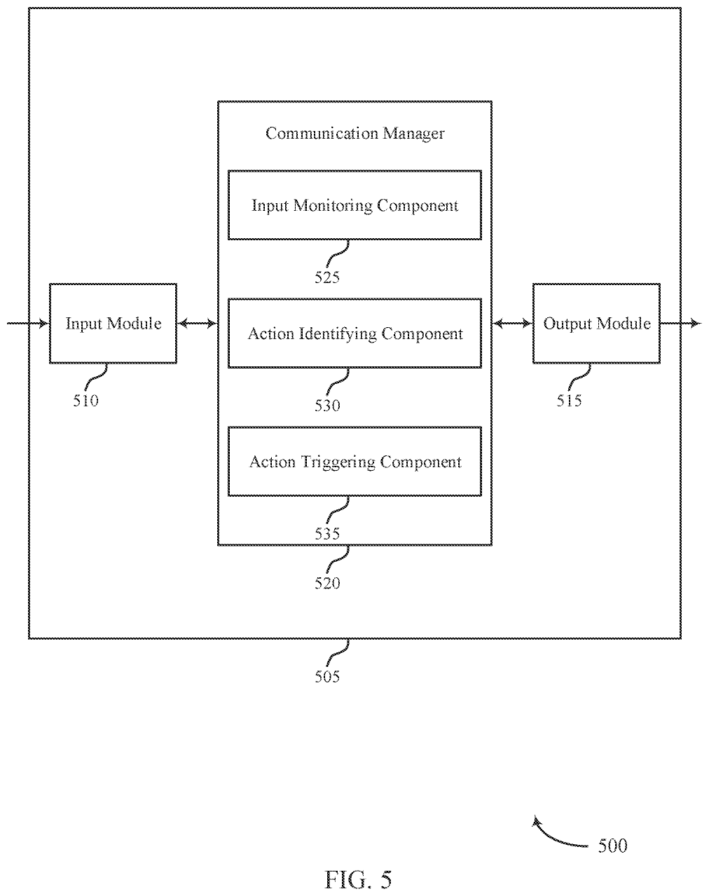

FIG. 5 shows a block diagram 500 of a device 505 that supports dynamic action identification for communication platform in accordance with aspects of the present disclosure. The device 505 may include an input module 510, an output module 515, and a communication manager 520. The device 505 may also include a processor. Each of these components may be in communication with one another (e.g., via one or more buses).

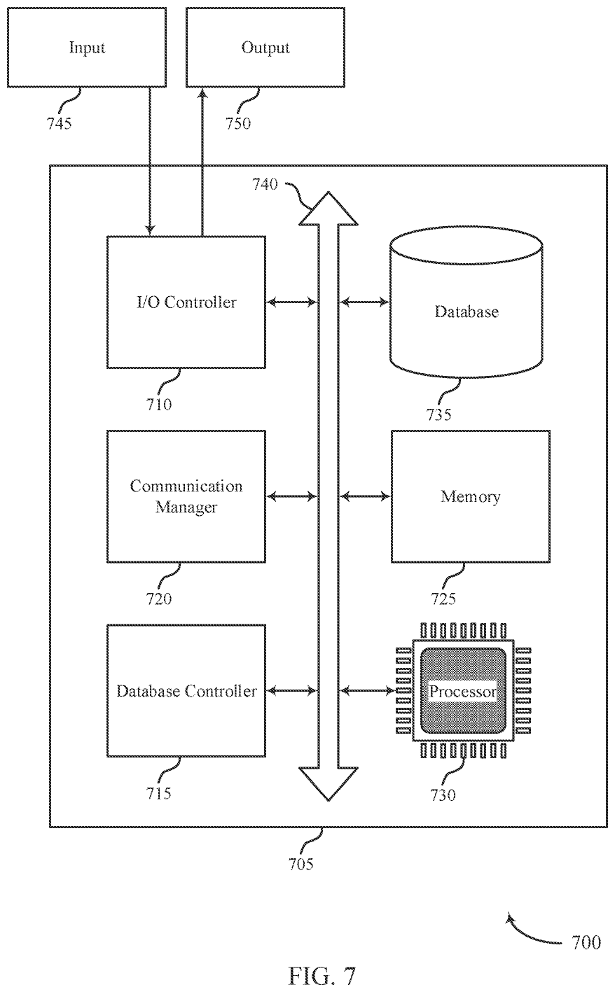

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the communication manager 520 to support dynamic action identification for communication platform. In some cases, the input module 510 may be a component of an I/O controller 710 as described with reference to FIG. 7.

The output module 515 may manage output signals for the device 505. For example, the output module 515 may receive signals from other components of the device 505, such as the communication manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the communication manager 520 may include an input monitoring component 525, an action identifying component 530, an action triggering component 535, or any combination thereof. In some examples, the communication manager 520, or various components thereof, may be configured to perform various operations (e.g., receiving, monitoring, transmitting) using or otherwise in cooperation with the input module 510, the output module 515, or both. For example, the communication manager 520 may receive information from the input module 510, send information to the output module 515, or be integrated in combination with the input module 510, the output module 515, or both to receive information, transmit information, or perform various other operations as described herein.

The communication manager 520 may support data processing in accordance with examples as disclosed herein. The input monitoring component 525 may be configured as or otherwise support a means for monitoring, by a communication service that is a participant to a channel of a communication platform, a plurality of inputs into the channel by other participants to the channel, wherein the communication service is configured to execute one or more machine learning models and access one or more external data platforms that are linked to the channel. The action identifying component 530 may be configured as or otherwise support a means for identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform. The action triggering component 535 may be configured as or otherwise support a means for triggering, by the communication service and based at least in part on identifying the action, execution of the action using data from the first external data platform.

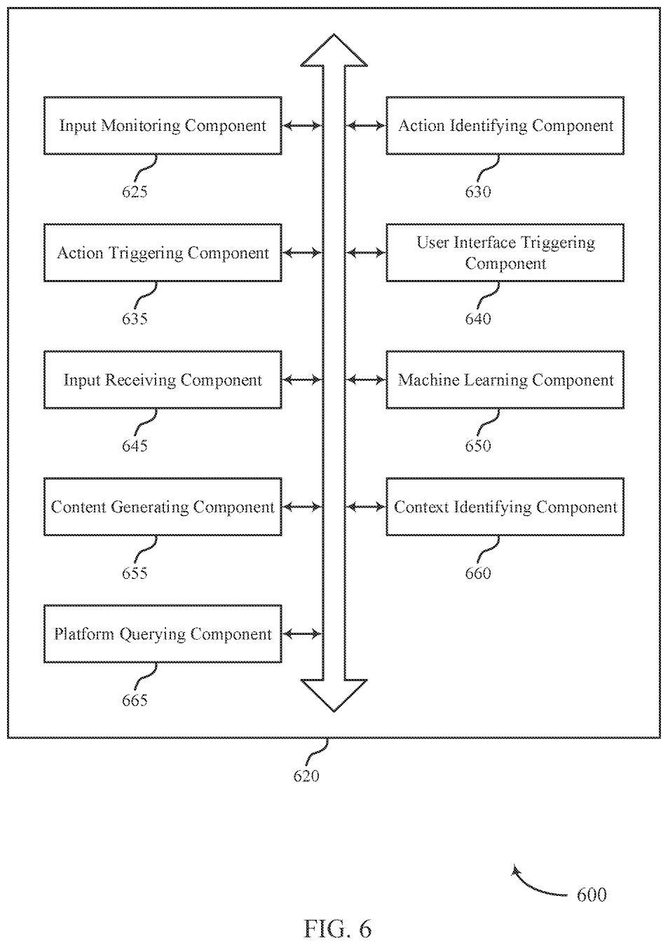

FIG. 6 shows a block diagram 600 of a communication manager 620 that supports dynamic action identification for communication platform in accordance with aspects of the present disclosure. The communication manager 620 may be an example of aspects of a communication manager or a communication manager 520, or both, as described herein. The communication manager 620, or various components thereof, may be an example of means for performing various aspects of dynamic action identification for communication platform as described herein. For example, the communication manager 620 may include an input monitoring component 625, an action identifying component 630, an action triggering component 635, a user interface triggering component 640, an input receiving component 645, a machine learning component 650, a content generating component 655, a context identifying component 660, a platform querying component 665, or any combination thereof. Each of these components may communicate, directly or indirectly, with one another (e.g., via one or more buses).

The communication manager 620 may support data processing in accordance with examples as disclosed herein. The input monitoring component 625 may be configured as or otherwise support a means for monitoring, by a communication service that is a participant to a channel of a communication platform, a plurality of inputs into the channel by other participants to the channel, wherein the communication service is configured to execute one or more machine learning models and access one or more external data platforms that are linked to the channel. In some examples, the plurality of inputs comprises a set of messages, temporal data associated with the set of messages, a set of data attributes associated with the other participants to the channel, configuration data associated with the channel, or a combination thereof. In some examples, each of the one or more external data platforms is associated with a different set of preconfigured actions for the communication platform.

The action identifying component 630 may be configured as or otherwise support a means for identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform. The action triggering component 635 may be configured as or otherwise support a means for triggering, by the communication service and based at least in part on identifying the action, execution of the action using data from the first external data platform.

In some examples, to support triggering execution of the action, the action triggering component 635 may be configured as or otherwise support a means for triggering execution of the action such that the action is executed at the first external data platform.

In some examples, the user interface triggering component 640 may be configured as or otherwise support a means for triggering, by the communication service, display of a user interface component at the communication platform, wherein the user interface component includes an indication of the action and an indication of the data of the first external data platform. In some examples, the user interface component comprises a sidebar with a set of interactive components. In some examples, the user interface component comprises an input into the channel of the communication platform.

In some examples, the input receiving component 645 may be configured as or otherwise support a means for receiving, at the communication service, input comprising selection of the action, the data, or both at the user interface component, wherein execution of the action is triggered based at least in part on receiving the input comprising the selection.

In some examples, the content generating component 655 may be configured as or otherwise support a means for generating, by the communication service, a set of content items based at least in part on the data from the first external data platform. In some examples, the user interface triggering component 640 may be configured as or otherwise support a means for triggering display of the set of content items at the user interface component. In some examples, the set of content items comprises one or more of a document, a user profile, a work item, or a uniform resource locator associated with the first external data platform.

In some examples, to support receiving the indication of the selection of the action, the machine learning component 650 may be configured as or otherwise support a means for updating, by the communication service, the one or more machine learning models based at least in part on the received user input.

In some examples, the machine learning component 650 may be configured as or otherwise support a means for performing, by the one or more machine learning models, a natural language processing analysis on one or more of the plurality of inputs, wherein identifying the action is based at least in part on performing the natural language processing analysis.

In some examples, the context identifying component 660 may be configured as or otherwise support a means for identifying, by the communication service and based at least in part on performing the natural language processing analysis, a communication context associated with the channel. In some examples, the platform querying component 665 may be configured as or otherwise support a means for querying, by the communication service, the one or more external data platforms based at least in part on the communication context.

In some examples, the platform querying component 665 may be configured as or otherwise support a means for receiving, by the communication service and in response to querying the one or more external data platforms, the data from the first external data platform. In some examples, the action identifying component 630 may be configured as or otherwise support a means for identifying, by the communication service, the set of actions based at least in part on receiving the data from the first external data platform. In some examples, the action triggering component 635 may be configured as or otherwise support a means for selecting, by the communication service, the action from the identified set of actions based at least in part on the data from the first external data platform and the communication context associated with the channel.

FIG. 7 shows a diagram of a system 700 including a device 705 that supports dynamic action identification for communication platform in accordance with aspects of the present disclosure. The device 705 may be an example of or include the components of a device 505 as described herein. The device 705 may include components for bi-directional data communications including components for transmitting and receiving communications, such as a communication manager 720, an I/O controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a basic I/O system (BIOS) which may control basic hardware or software operation such as the interaction with peripheral components or devices.

The processor 730 may include an intelligent hardware device, (e.g., a general-purpose processor, a digital signal processor (DSP), a CPU, a microcontroller, an ASIC, a field-programmable gate array (FPGA), a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting dynamic action identification for communication platform).

The communication manager 720 may support data processing in accordance with examples as disclosed herein. For example, the communication manager 720 may be configured as or otherwise support a means for monitoring, by a communication service that is a participant to a channel of a communication platform, a plurality of inputs into the channel by other participants to the channel, wherein the communication service is configured to execute one or more machine learning models and access one or more external data platforms that are linked to the channel. The communication manager 720 may be configured as or otherwise support a means for identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform. The communication manager 720 may be configured as or otherwise support a means for triggering, by the communication service and based at least in part on identifying the action, execution of the action using data from the first external data platform.

By including or configuring the communication manager 720 in accordance with examples as described herein, the device 705 may support techniques for improved user experience at a communication platform based on using a communication service to autonomously trigger actions associated with the communication platform. As such, the described techniques may enable users of the communication platform to perform actions with reduced manual interaction and greater efficiency, among other benefits.

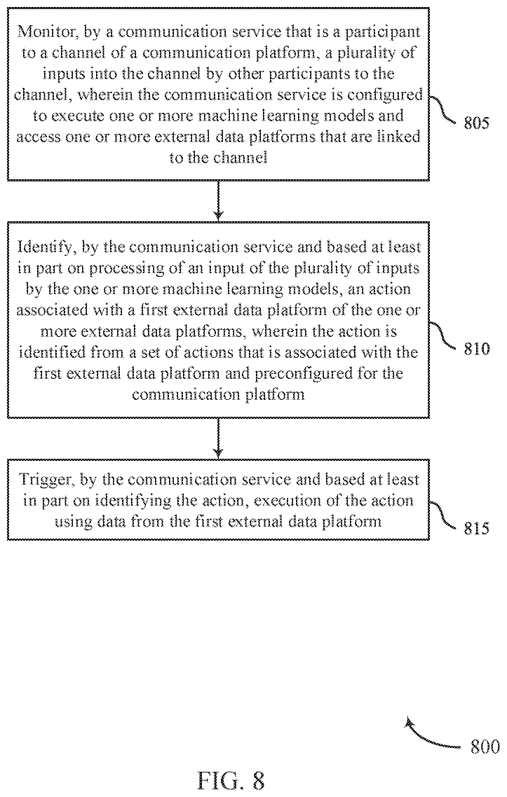

FIG. 8 shows a flowchart illustrating a method 800 that supports dynamic action identification for communication platform in accordance with aspects of the present disclosure. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 805, the method may include monitoring, by a communication service that is a participant to a channel of a communication platform, a plurality of inputs into the channel by other participants to the channel, wherein the communication service is configured to execute one or more machine learning models and access one or more external data platforms that are linked to the channel. The operations of 805 may be performed in accordance with examples as disclosed herein. In some examples, aspects of the operations of 805 may be performed by an input monitoring component 625 as described with reference to FIG. 6.

At 810, the method may include identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform. The operations of 810 may be performed in accordance with examples as disclosed herein. In some examples, aspects of the operations of 810 may be performed by an action identifying component 630 as described with reference to FIG. 6.

At 815, the method may include triggering, by the communication service and based at least in part on identifying the action, execution of the action using data from the first external data platform. The operations of 815 may be performed in accordance with examples as disclosed herein. In some examples, aspects of the operations of 815 may be performed by an action triggering component 635 as described with reference to FIG. 6.

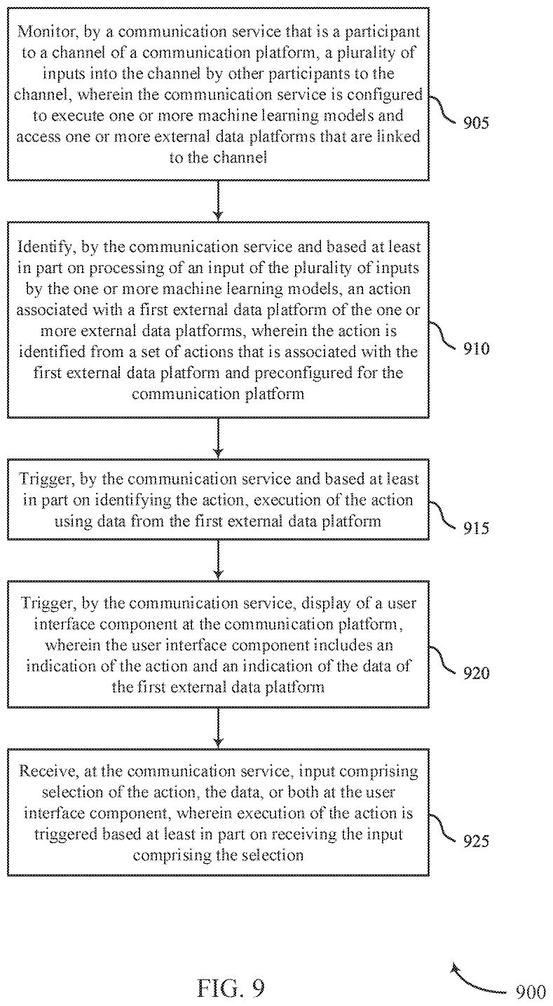

FIG. 9 shows a flowchart illustrating a method 900 that supports dynamic action identification for communication platform in accordance with aspects of the present disclosure. The operations of the method 900 may be implemented by an application server or its components as described herein. For example, the operations of the method 900 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 905, the method may include monitoring, by a communication service that is a participant to a channel of a communication platform, a plurality of inputs into the channel by other participants to the channel, wherein the communication service is configured to execute one or more machine learning models and access one or more external data platforms that are linked to the channel. The operations of 905 may be performed in accordance with examples as disclosed herein. In some examples, aspects of the operations of 905 may be performed by an input monitoring component 625 as described with reference to FIG. 6.

At 910, the method may include identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform. The operations of 910 may be performed in accordance with examples as disclosed herein. In some examples, aspects of the operations of 910 may be performed by an action identifying component 630 as described with reference to FIG. 6.

At 915, the method may include triggering, by the communication service and based at least in part on identifying the action, execution of the action using data from the first external data platform. The operations of 915 may be performed in accordance with examples as disclosed herein. In some examples, aspects of the operations of 915 may be performed by an action triggering component 635 as described with reference to FIG. 6.

At 920, the method may include triggering, by the communication service, display of a user interface component at the communication platform, wherein the user interface component includes an indication of the action and an indication of the data of the first external data platform. The operations of 920 may be performed in accordance with examples as disclosed herein. In some examples, aspects of the operations of 920 may be performed by a user interface triggering component 640 as described with reference to FIG. 6.

At 925, the method may include receiving, at the communication service, input comprising selection of the action, the data, or both at the user interface component, wherein execution of the action is triggered based at least in part on receiving the input comprising the selection. The operations of 925 may be performed in accordance with examples as disclosed herein. In some examples, aspects of the operations of 925 may be performed by an input receiving component 645 as described with reference to FIG. 6.

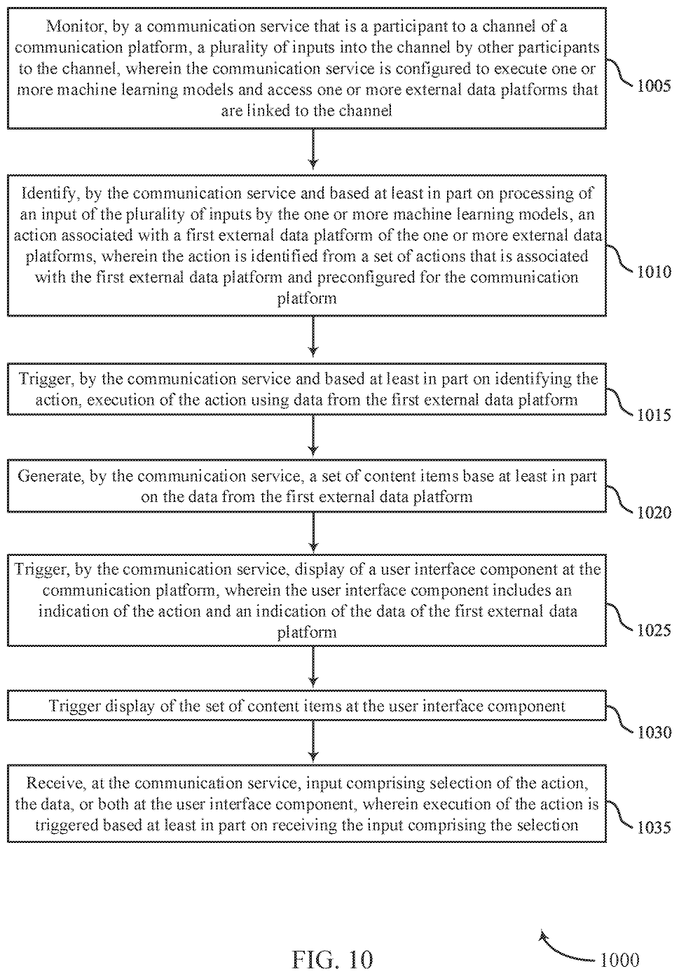

FIG. 10 shows a flowchart illustrating a method 1000 that supports dynamic action identification for communication platform in accordance with aspects of the present disclosure. The operations of the method 1000 may be implemented by an application server or its components as described herein. For example, the operations of the method 1000 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 1005, the method may include monitoring, by a communication service that is a participant to a channel of a communication platform, a plurality of inputs into the channel by other participants to the channel, wherein the communication service is configured to execute one or more machine learning models and access one or more external data platforms that are linked to the channel. The operations of 1005 may be performed in accordance with examples as disclosed herein. In some examples, aspects of the operations of 1005 may be performed by an input monitoring component 625 as described with reference to FIG. 6.

At 1010, the method may include identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform. The operations of 1010 may be performed in accordance with examples as disclosed herein. In some examples, aspects of the operations of 1010 may be performed by an action identifying component 630 as described with reference to FIG. 6.

At 1015, the method may include triggering, by the communication service and based at least in part on identifying the action, execution of the action using data from the first external data platform. The operations of 1015 may be performed in accordance with examples as disclosed herein. In some examples, aspects of the operations of 1015 may be performed by an action triggering component 635 as described with reference to FIG. 6.

At 1020, the method may include triggering, by the communication service, display of a user interface component at the communication platform, wherein the user interface component includes an indication of the action and an indication of the data of the first external data platform. The operations of 1020 may be performed in accordance with examples as disclosed herein. In some examples, aspects of the operations of 1020 may be performed by a user interface triggering component 640 as described with reference to FIG. 6.

At 1025, the method may include receiving, at the communication service, input comprising selection of the action, the data, or both at the user interface component, wherein execution of the action is triggered based at least in part on receiving the input comprising the selection. The operations of 1025 may be performed in accordance with examples as disclosed herein. In some examples, aspects of the operations of 1025 may be performed by an input receiving component 645 as described with reference to FIG. 6.

At 1030, the method may include generating, by the communication service, a set of content items based at least in part on the data from the first external data platform. The operations of 1030 may be performed in accordance with examples as disclosed herein. In some examples, aspects of the operations of 1030 may be performed by a content generating component 655 as described with reference to FIG. 6.

At 1035, the method may include triggering display of the set of content items at the user interface component. The operations of 1035 may be performed in accordance with examples as disclosed herein. In some examples, aspects of the operations of 1035 may be performed by a user interface triggering component 640 as described with reference to FIG. 6.

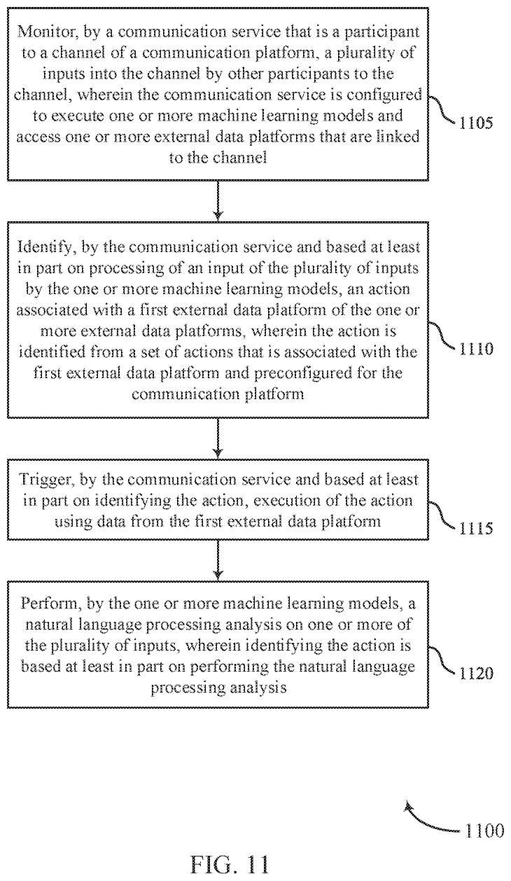

FIG. 11 shows a flowchart illustrating a method 1100 that supports dynamic action identification for communication platform in accordance with aspects of the present disclosure. The operations of the method 1100 may be implemented by an application server or its components as described herein. For example, the operations of the method 1100 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 1105, the method may include monitoring, by a communication service that is a participant to a channel of a communication platform, a plurality of inputs into the channel by other participants to the channel, wherein the communication service is configured to execute one or more machine learning models and access one or more external data platforms that are linked to the channel. The operations of 1105 may be performed in accordance with examples as disclosed herein. In some examples, aspects of the operations of 1105 may be performed by an input monitoring component 625 as described with reference to FIG. 6.

At 1110, the method may include identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform. The operations of 1110 may be performed in accordance with examples as disclosed herein. In some examples, aspects of the operations of 1110 may be performed by an action identifying component 630 as described with reference to FIG. 6.

At 1115, the method may include triggering, by the communication service and based at least in part on identifying the action, execution of the action using data from the first external data platform. The operations of 1115 may be performed in accordance with examples as disclosed herein. In some examples, aspects of the operations of 1115 may be performed by an action triggering component 635 as described with reference to FIG. 6.

At 1120, the method may include performing, by the one or more machine learning models, a natural language processing analysis on one or more of the plurality of inputs, wherein identifying the action is based at least in part on performing the natural language processing analysis. The operations of 1120 may be performed in accordance with examples as disclosed herein. In some examples, aspects of the operations of 1120 may be performed by a machine learning component 650 as described with reference to FIG. 6.

A method for data processing is described. The method may include monitoring, by a communication service that is a participant to a channel of a communication platform, a plurality of inputs into the channel by other participants to the channel, wherein the communication service is configured to execute one or more machine learning models and access one or more external data platforms that are linked to the channel, identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform, and triggering, by the communication service and based at least in part on identifying the action, execution of the action using data from the first external data platform.

An apparatus for data processing is described. The apparatus may include a processor, memory coupled with the processor, and instructions stored in the memory. The instructions may be executable by the processor to cause the apparatus to monitor, by a communication service that is a participant to a channel of a communication platform, a plurality of inputs into the channel by other participants to the channel, wherein the communication service is configured to execute one or more machine learning models and access one or more external data platforms that are linked to the channel, identify, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform, and trigger, by the communication service and based at least in part on identifying the action, execution of the action using data from the first external data platform.

Another apparatus for data processing is described. The apparatus may include means for monitoring, by a communication service that is a participant to a channel of a communication platform, a plurality of inputs into the channel by other participants to the channel, wherein the communication service is configured to execute one or more machine learning models and access one or more external data platforms that are linked to the channel, means for identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform, and means for triggering, by the communication service and based at least in part on identifying the action, execution of the action using data from the first external data platform.

A non-transitory computer-readable medium storing code for data processing is described. The code may include instructions executable by a processor to monitor, by a communication service that is a participant to a channel of a communication platform, a plurality of inputs into the channel by other participants to the channel, wherein the communication service is configured to execute one or more machine learning models and access one or more external data platforms that are linked to the channel, identify, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform, and trigger, by the communication service and based at least in part on identifying the action, execution of the action using data from the first external data platform.

In some examples of the method, apparatuses, and non-transitory computer-readable medium described herein, triggering execution of the action may include operations, features, means, or instructions for triggering execution of the action such that the action may be executed at the first external data platform.

Some examples of the method, apparatuses, and non-transitory computer-readable medium described herein may further include operations, features, means, or instructions for triggering, by the communication service, display of a user interface component at the communication platform, wherein the user interface component includes an indication of the action and an indication of the data of the first external data platform and receiving, at the communication service, input comprising selection of the action, the data, or both at the user interface component, wherein execution of the action may be triggered based at least in part on receiving the input comprising the selection.

In some examples of the method, apparatuses, and non-transitory computer-readable medium described herein, generating, by the communication service, a set of content items based at least in part on the data from the first external data platform and triggering display of the set of content items at the user interface component.

In some examples of the method, apparatuses, and non-transitory computer-readable medium described herein, the set of content items comprises one or more of a document, a user profile, a work item, or a uniform resource locator associated with the first external data platform.

In some examples of the method, apparatuses, and non-transitory computer-readable medium described herein, receiving the indication of the selection of the action may include operations, features, means, or instructions for updating, by the communication service, the one or more machine learning models based at least in part on the received user input.

In some examples of the method, apparatuses, and non-transitory computer-readable medium described herein, the user interface component comprises a sidebar with a set of interactive components.

In some examples of the method, apparatuses, and non-transitory computer-readable medium described herein, the user interface component comprises an input into the channel of the communication platform.

Some examples of the method, apparatuses, and non-transitory computer-readable medium described herein may further include operations, features, means, or instructions for performing, by the one or more machine learning models, a natural language processing analysis on one or more of the plurality of inputs, wherein identifying the action may be based at least in part on performing the natural language processing analysis.

Some examples of the method, apparatuses, and non-transitory computer-readable medium described herein may further include operations, features, means, or instructions for identifying, by the communication service and based at least in part on performing the natural language processing analysis, a communication context associated with the channel and querying, by the communication service, the one or more external data platforms based at least in part on the communication context.

Some examples of the method, apparatuses, and non-transitory computer-readable medium described herein may further include operations, features, means, or instructions for receiving, by the communication service and in response to querying the one or more external data platforms, the data from the first external data platform, identifying, by the communication service, the set of actions based at least in part on receiving the data from the first external data platform, and selecting, by the communication service, the action from the identified set of actions based at least in part on the data from the first external data platform and the communication context associated with the channel.

In some examples of the method, apparatuses, and non-transitory computer-readable medium described herein, each of the one or more external data platforms may be associated with a different set of preconfigured actions for the communication platform.

In some examples of the method, apparatuses, and non-transitory computer-readable medium described herein, the plurality of inputs comprises a set of messages, temporal data associated with the set of messages, a set of data attributes associated with the other participants to the channel, configuration data associated with the channel, or a combination thereof.

It should be noted that the methods described herein describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
monitoring, by a communication service that is a participant to a channel of a communication platform, a plurality of inputs into the channel by other participants to the channel, wherein the communication service is configured to execute one or more machine learning models and access one or more external data platforms that are linked to the channel;
identifying, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform; and
triggering, by the communication service and based at least in part on identifying the action, execution of the action using data from the first external data platform.

2. The method of claim 1, wherein triggering execution of the action comprises:
triggering execution of the action such that the action is executed at the first external data platform.

3. The method of claim 1, further comprising:
triggering, by the communication service, display of a user interface component at the communication platform, wherein the user interface component includes an indication of the action and an indication of the data of the first external data platform;
receiving, at the communication service, input comprising selection of the action, the data, or both at the user interface component, wherein execution of the action is triggered based at least in part on receiving the input comprising the selection.

4. The method of claim 3, further comprising:
generating, by the communication service, a set of content items based at least in part on the data from the first external data platform; and
triggering display of the set of content items at the user interface component.

5. The method of claim 4, wherein the set of content items comprises one or more of a document, a user profile, a work item, or a uniform resource locator associated with the first external data platform.

6. The method of claim 3, wherein receiving the indication of the selection of the action comprises:
updating, by the communication service, the one or more machine learning models based at least in part on the received input.

7. The method of claim 3, wherein the user interface component comprises a sidebar with a set of interactive components.

8. The method of claim 3, wherein the user interface component comprises an input into the channel of the communication platform.

9. The method of claim 1, further comprising:
performing, by the one or more machine learning models, a natural language processing analysis on one or more of the plurality of inputs, wherein identifying the action is based at least in part on performing the natural language processing analysis.

10. The method of claim 9, further comprising:
identifying, by the communication service and based at least in part on performing the natural language processing analysis, a communication context associated with the channel; and
querying, by the communication service, the one or more external data platforms based at least in part on the communication context.

11. The method of claim 10, further comprising:
receiving, by the communication service and in response to querying the one or more external data platforms, the data from the first external data platform;
identifying, by the communication service, the set of actions based at least in part on receiving the data from the first external data platform; and
selecting, by the communication service, the action from the identified set of actions based at least in part on the data from the first external data platform and the communication context associated with the channel.

12. The method of claim 1, wherein each of the one or more external data platforms is associated with a different set of preconfigured actions for the communication platform.

13. The method of claim 1, wherein the plurality of inputs comprises a set of messages, temporal data associated with the set of messages, a set of data attributes associated with the other participants to the channel, configuration data associated with the channel, or a combination thereof.

14. An apparatus for data processing, comprising:
a processor;
memory coupled with the processor; and
instructions stored in the memory and executable by the processor to cause the apparatus to:
monitor, by a communication service that is a participant to a channel of a communication platform, a plurality of inputs into the channel by other participants to the channel, wherein the communication service is configured to execute one or more machine learning models and access one or more external data platforms that are linked to the channel;
identify, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform; and
trigger, by the communication service and based at least in part on identifying the action, execution of the action using data from the first external data platform.

15. The apparatus of claim 14, wherein the instructions to trigger execution of the action are executable by the processor to cause the apparatus to:
trigger execution of the action such that the action is executed at the first external data platform.

16. The apparatus of claim 14, wherein the instructions are further executable by the processor to cause the apparatus to:
trigger, by the communication service, display of a user interface component at the communication platform, wherein the user interface component includes an indication of the action and an indication of the data of the first external data platform;
receive, at the communication service, input comprising selection of the action, the data, or both at the user interface component, wherein execution of the action is triggered based at least in part on receiving the input comprising the selection.

17. The apparatus of claim 16, wherein the instructions are further executable by the processor to cause the apparatus to:
generate, by the communication service, a set of content items based at least in part on the data from the first external data platform; and
trigger display of the set of content items at the user interface component.

18. The apparatus of claim 17, wherein the set of content items comprises one or more of a document, a user profile, a work item, or a uniform resource locator associated with the first external data platform.

19. The apparatus of claim 16, wherein the instructions to receive the indication of the selection of the action are executable by the processor to cause the apparatus to:
update, by the communication service, the one or more machine learning models based at least in part on the received input.

20. A non-transitory computer-readable medium storing code for data processing, the code comprising instructions executable by a processor to:
monitor, by a communication service that is a participant to a channel of a communication platform, a plurality of inputs into the channel by other participants to the channel, wherein the communication service is configured to execute one or more machine learning models and access one or more external data platforms that are linked to the channel;
identify, by the communication service and based at least in part on processing of an input of the plurality of inputs by the one or more machine learning models, an action associated with a first external data platform of the one or more external data platforms, wherein the action is identified from a set of actions that is associated with the first external data platform and preconfigured for the communication platform; and
trigger, by the communication service and based at least in part on identifying the action, execution of the action using data from the first external data platform.
